(19) United States
(12) Patent Application Publication
(10) Pub. No.: US 2015/0377479 A1
(43) Pub. Date: Dec. 31, 2015

(54) INTEGRATED LIGHTING AND NETWORK INTERFACE DEVICE

(71) Applicant: BAE SYSTEMS PLC, London (GB)

(72) Inventors: CHRISTOPHER RALPH PESCOD, Chelmsford, Essex (GB); COLIN JAMES HARPER, Chelmsford, Essex (GB)

(73) Assignee: BAE SYSTEMS plc, London (GB)

(21) Appl. No.: 14/766,622

(22) PCT Filed: Feb. 17, 2014
(86) PCT No.: PCT/GB2014/050454

§ 371 Date: Aug. 7, 2015

(30) Foreign Application Priority Data
Feb. 18, 2013 (EP) 13275035.7
Feb. 18, 2013 (GB) 1302762.8

(51) Int. Cl. F21V 33/00; F21V 5/04; H01Q 1/22; G02B 6/42

(52) U.S. Cl. CPC F21V 33/0052; G02B 6/4292; F21V 5/043; H01Q 1/22; F21W 2131/402

(57) ABSTRACT

There is disclosed an integrated lighting and network-interface device comprising a housing defining an aperture, a lens supported at the aperture for allowing light and 55-65 GHz radiation to pass therethrough, a light source, a transceiver module having an antenna unit, the transceiver module being adapted for connection to an optic fibre port, and being for operation at at least one centre frequency between 55 GHz and 65 GHz, wherein the light source and the antenna unit are disposed in the housing and arranged to radiate through the lens.

The present invention relates to an integrated lighting and network-interface device. In particular, though not exclusively, the device is for deployment in a building or other construction comprising many partitioned volumes such as rooms, and especially such as small rooms (e.g. 4 m×4 m).

In many working or living situations, a person may habitually occupy a room or volume and desire the provision of certain services and/or devices. For example, it may be desirable to provide the room with artificial lighting, a data connection (e.g. a data connection to the internet or an intranet), environmental control (e.g. a temperature sensor), and various alarms (e.g. to alert of fire as inferred by the detection of smoke).

In general, a specific device is known for each such desire and each device is small in size in comparison to the room.

According to a first aspect of the invention there is provided an integrated lighting and network-interface device comprising a housing defining an aperture, a lens supported at the aperture for allowing light and 55-65 GHz radiation to pass therethrough, a light source, a transceiver module having an antenna unit, the transceiver module being adapted for connection to an optic fibre port, and being for operation at at least one centre frequency between 55 GHz and 65 GHz, wherein the light source and the antenna unit are disposed in the housing and arranged to radiate through the lens.

Thus the device provides a single fixture which may provide lighting and networked data communications to a room or area. Installation of such a single fixture may be quicker than the equivalent separate light fixture and 55-65 GHz communications fixtures. Further, such a single fixture may tend on aggregate to occupy less space once installed, and can use only a single power supply feed.

The choice of a transceiver module operating with a 55-65 GHz centre frequency provides for a signal that is readily absorbed by the surrounding walls and atmosphere (for example the oxygen molecules in the air introduce attenuation of 16 dB/km) and therefore tends to provide a signal hotspot that is highly localised. Such a localised signal hotspot can assist with maintaining secure communications. Further, such localised signal hotspots allow re-use of frequencies between coverage cells (as opposed to needing to have a distinct frequency assigned to each communication link established across adjacent cells in the network).

By having the transceiver module and light source within the same housing and illuminating the same lens, there can tend to be provided a substantially similar coverage of visible light and 55 GHz to 65 GHz radiation.

The device may comprise a modem, the modem being for interfacing the transceiver module with the fibre optic port.

The modem may implement a COFDM or WDMA protocol and may further comprise a FEC processing module. Such a modem and module may be present in the transceiver module or may be executable in conjunction with a processor provided at the device.

The light source may be rated at between 30 and 60 W.

As such the light source may provide sufficient light to illuminate a room. In particular, the light source may emit in the region of 34 to 38 W.

The device may comprise a processor configured to communicate with the light source and with the 55-65 GHz transceiver.

Such a provision enables the lighting to be controlled remotely by commands or instructions sent over the network. For instance, whilst the majority of the network channel capacity may be used for the 55-65 GHz data communications signal, a portion of the capacity may be set aside for instructions such as ‘dim the light’ or ‘turn the light off’ or ‘flash the light’. Such an instruction may be issued centrally over the network, or may be issued by a local client communicating over the particular 55-65 GHz link.

The lens may comprise an outer surface facing away from the transceiver, and an inner surface facing the transceiver, and wherein the lens further may comprise a raised-profile portion, the raised-profile portion defining a profile axis and having about the profile axis a generally gull-wing cross-section so as to define on the outer surface of the raised-profile lens a valley interposed between a pair of peaks, the valley coinciding with the profile axis and wherein the transceiver module may be arranged such that the boresight of the antenna unit is proximate to the profile axis of the lens.

The provision of such a lens tends to provide a sec² beam pattern for the RF radiation and thus can tend to ensure that the far field radiation pattern of the 55-65 GHz antenna is broadly distributed and evenly distributed where the device it provided in the centre of a ceiling of a rectangular room.

Thus, where the device is deployed in a room, a user may expect to be able to communicate with the transceiver module from most positions in the room.

In general the boresight of the antenna unit will be proximate by virtue of being closer to the profile axis than to a peak axis extending from a peak of the raised-profile portion and being parallel to the profile axis. In some embodiments, the boresight of the transceiver may be substantially collinear or collinear with the profile axis.

By way of explanation, by having the gull-wing cross section, the lens is shaped such that it has a point of inflexion between the centre and the edge. Where the lens is radially symmetric, i.e. has a gull-wing cross-section regardless of which through-axis cross section is chosen, the lens has an annular line of inflection between the centre and the edge of the disc which tends to define the outer surface having a concave surface portion at the centre surrounded by a toroidal ridge.

The inner surface of the lens may comprise a convex surface portion at the profile axis which is surrounded by a toroidal concavity, and wherein the light sources are proximate to the torroidal concavity.

Such an arrangement can provide a relatively narrow beam of light and as such can be suited for spotlighting applications.

The light source, the antenna unit and the lens may be configured such that in use the radiation pattern of the antenna unit and the radiation pattern of the light source illuminate substantially the same volume.

Thus a single device can be used for a given volume to maximise the use of space, and the users can have confidence that a RF signal should be available where the device illuminates with visible radiation.

The device may comprise a plurality of light sources arranged around the transceiver module and generally occupying the space defined under the lens.

The lens may be formed from High Density Polyethylene or Polycarbonate.

Such materials permit visible light and 55-65 GHz radiation to pass, and may also be shaped or formed in a cost efficient manner.

The device may further comprise environmental sensors, which are configured to communicate with the processor.

The provision of environmental sensors further contributes to the possibility of saving space where various devices need to be installed, as may be particularly relevant where the devices are to be installed in a building or large sea vessel. The sensors may be smoke sensors, temperature sensors or light sensors. Other sensor for monitoring ambient conditions may be provided.

The housing may comprise a base and walls extending from the base to the lens, such that the lens, base and walls provide an enclosure.

The base may be circular, the lens may be circular so as to correspond to the base, and the light source may comprise a plurality of light sources arranged around the transceiver in a ring.

Such an arrangement can tend to provide a spotlight and may be suited to illuminating a cylindrical volume, or to highlighting a feature within a volume.

Alternatively, the base may be rectangular, the lens may be rectangular so as to correspond to the base, and the light source may comprise an array of regularly spaced light sources arranged in a grid corresponding to the base.

Such an arrangement can tend to provide a more diffuse light and in particular may be suited to illuminating a cuboid volume when fixed to a boundary of that volume. For example, the device may be attached to the ceiling of a room having a generally rectangular floor plan.

The walls may comprise at least one piezoelectric actuator which is arranged to support the lens and the device may be provided with a signal generator for driving the piezoelectric actuators.

By thus mounting the lens on the piezoelectric actuators, the lens can be oscillated by the signal from the signal generator. The device thereby acts as a loudspeaker, or acoustic sounder with the lens functioning as a sound cone.

Whilst the lens may not be suitable for high fidelity sound broadcasts, it should be able to sound a warning such as a ringing or buzzing. Where the device is provided with sensors, the warning sound could be issued automatically where the processor determines that certain thresholds detected at the sensors have been exceeded.

The light source may comprise a plurality of LED units.

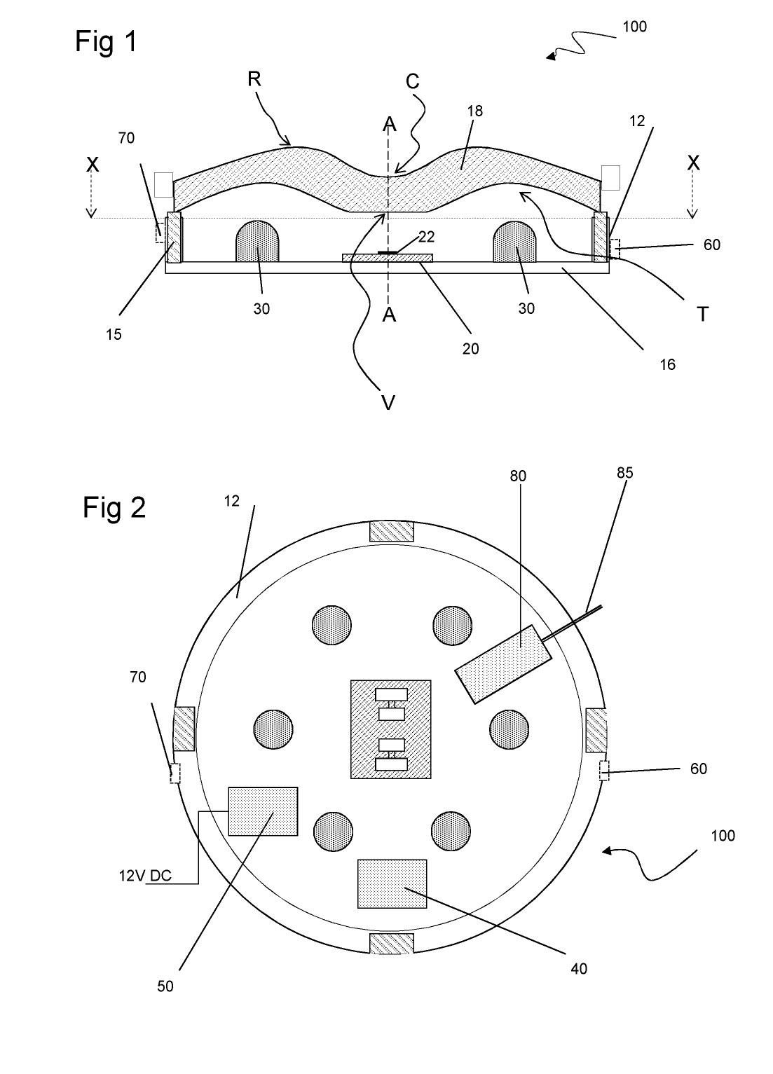

FIG. 1 shows a side-on view of a cross-section through a first embodiment of the invention;

FIG. 2 shows a top-down view of a cross-section through the embodiment of FIG. 1;

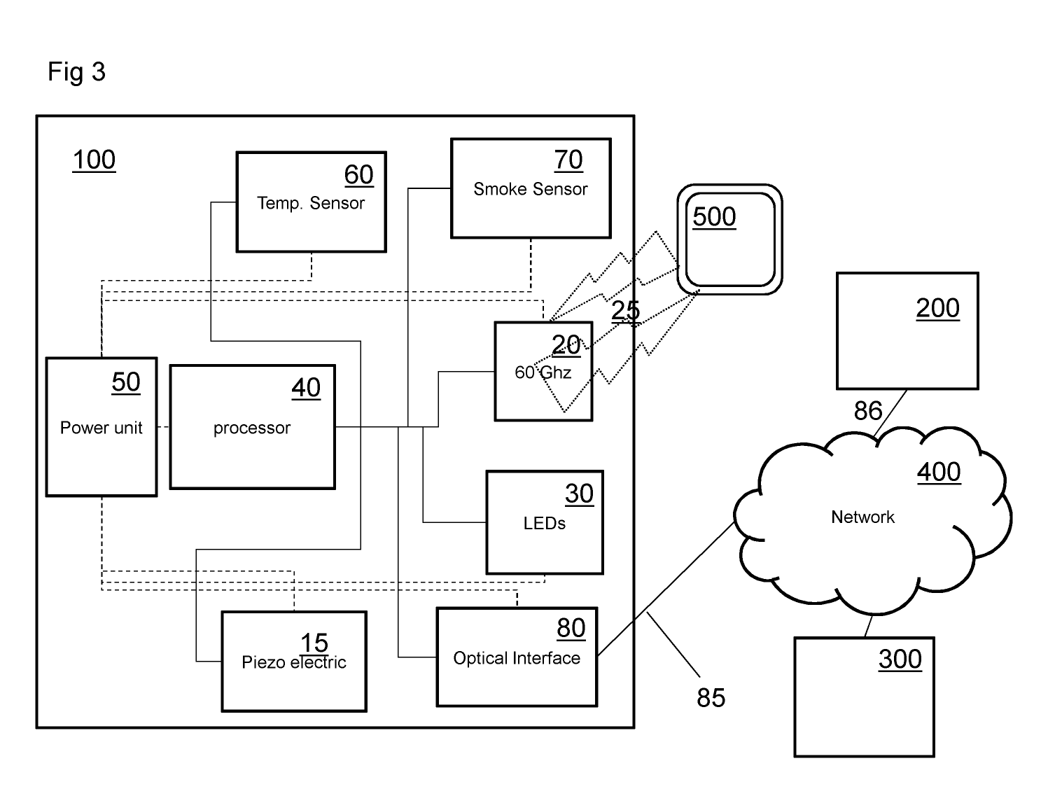

FIG. 3 shows a schematic diagram of the internal architecture of a device according to the invention and its relation to a network;

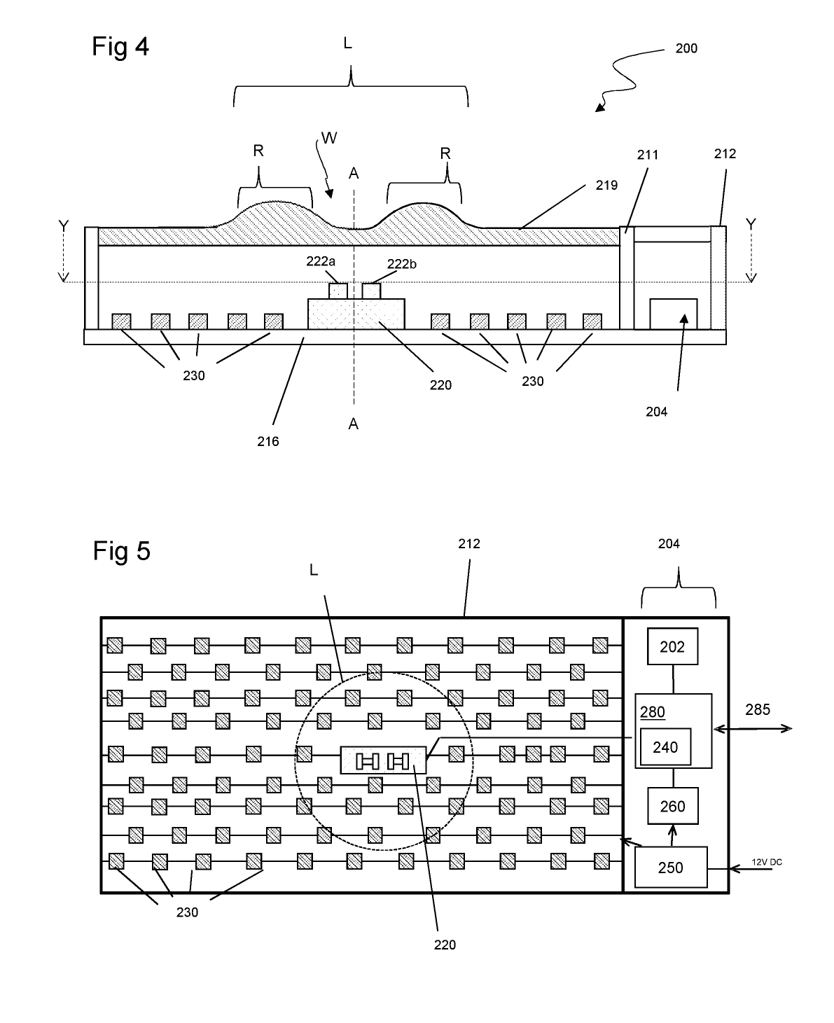

FIG. 4 shows a side-on view of a cross-section through a second embodiment of the invention; and

FIG. 5 shows a top-down view of the embodiment of FIG. 4; and

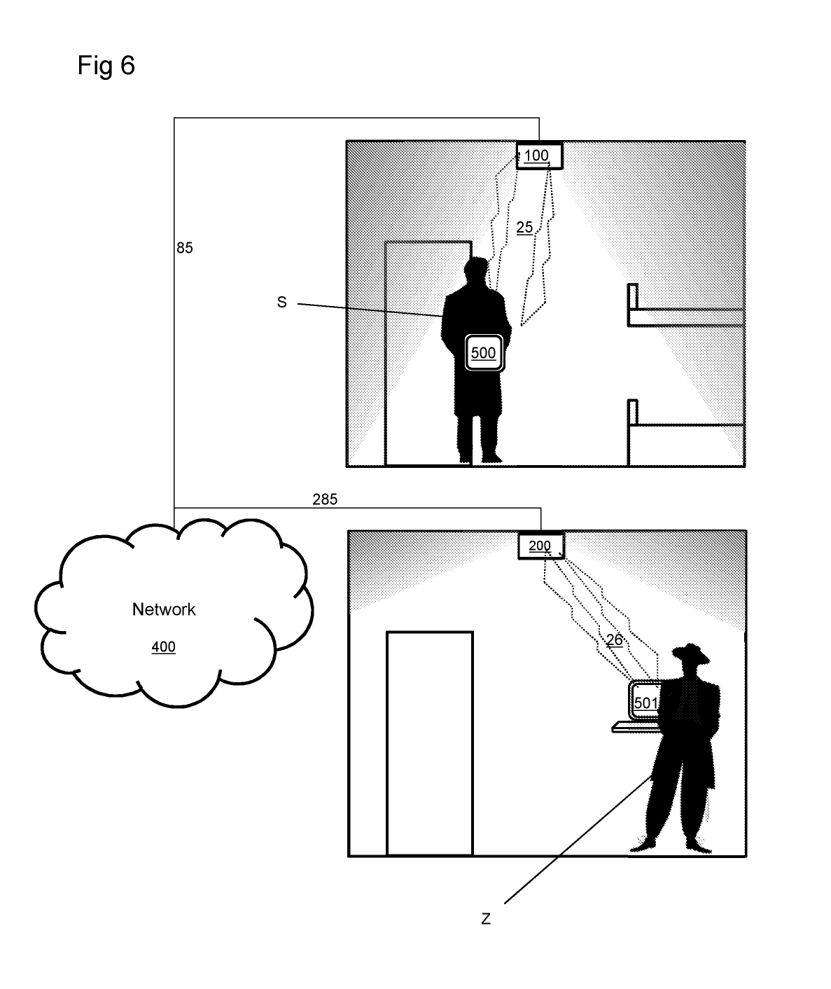

FIG. 6 shows devices according to the first and second embodiments of the invention, deployed in respective first and second rooms, the devices being connected to a network.

Referring particularly to FIGS. 1 and 2, the integrated lighting and communications network interface 100 comprises an enclosure defined by a base 16, a wall 12, and a lens 18. The base 16 is disc-shaped and the generally tubular wall 12 extends from the periphery of the base 16. The wall 12 supports the lens 18 which is generally disc-shaped and spans the entire wall 12 to cover the base 16 and define an enclosed cavity.

The enclosure 100 and lens 18 define an axis A-A about which the device is generally rotationally symmetric.

The lens 18 has a first, or internal, or lower, surface. Further the lens 18 has a second, or external, or upper surface. The first surface comprises a convex surface V at the centre which is surrounded by a toroidal trough T. The second surface comprises a concave surface C at the centre which is surrounded by a ridge R.

The thickness of the lens 18 between the first and second surfaces is approximately constant between perimeter and centrepoint. As such, the lens 18 provides a gull-wing shaped cross-section when ‘sliced’ through the central profile axis A-A. Gull-wing may be understood as a line having three points of inflection where one point is at the centre of the line and the other two are spaced apart either side of the central point.

The lens 18 is rigidly fixed to the wall 12 at piezoelectric actuators 15 which have the form of pillars. The lens 18 is further supported, by means of flexible bonding means, to the remaining upper surfaces of the wall 12.

Mounted on an external surface of the wall 12 is a smoke sensor 70 and a temperature sensor 60.

The base 16 comprises a circuit board for mounting electronic components.

Mounted to the base 16 directly beneath the convex surface V of the lens (or mounted at the central point of inflection of the gull-wing cross-section) is a transmit/receive module 20 for operation at a 60 GHz centre-frequency but may operate at a centre-frequency between 55-65 GHz. The Module 20 comprises a transmitter/receiver operably connected to an antenna unit 22, typically having the form of a patch antenna array.

The transceiver module 20 is arranged such that the boresight of the antenna unit 22 is approximately collinear with the profile axis A-A of the lens 18.

Surrounding the transceiver module 20 and mounted to the base 16 are a plurality of light emitting diode (LED) light sources 30. These LED light sources 30 tend to protrude further from the base 16 than the module 20 but can conveniently be arranged to protrude towards or into the torroidal trough T defined by the inner surface of the lens 18.

Further housed on the base 16 are a processor unit 40, a power unit 50 including a port to an external 12V power supply, and an optical interface 80 including a port to an optical fibre cable 85.

Referring to FIG. 3, the power unit 50 converts the input 12V DC supply into voltages as required to bias the electronic interface circuits associated with each of the temperature sensor 60, the processor 40, the smoke sensor 70, the transceiver module 20 operating at e.g. 60 GHz, the LED units 30, the optical interface 80 and the piezoelectric actuator 15. As such the unit 50 is arranged to provide power to combinations of components as necessary. The power unit 50 is provided with a back-up battery (not shown) for emergency operation.

Further, the processor 40 is directly electrically connected to and able to communicate with each of the temperature sensor 60, the power supply 50, the smoke sensor 70, the transceiver module 20, the LED units 30, the optical interface 80 and the piezoelectric actuators 15. As such, the processor 40 is arranged to issue instructions to, and receive information from, each of the components.

The optical interface 80 is connected by means of a high capacity optical fibre cable 85 (e.g. capable of supporting Ethernet data rates of between 1 GBit/s and 10 GBit/s) to a communications network 400. Further integrated lighting and communications network interface devices 200 and 300 are also connected to the network 400.

The transceiver operating at a 60 GHz centre-frequency 20 may interact with any client device, such as client device 500, local to the transceiver antenna 22 and operating under the same wireless communications protocol 25.

Referring to FIGS. 4 and 5, an alternative embodiment of an integrated lighting and communications network interface device is shown generally at 200. The device 200 has a general rectangular form.

Various features of this alternative embodiment are similar or equivalent to those in the embodiment of FIGS. 1 and 2. Where such similarity or equivalence exists, reference numerals have been incremented by a value of two hundred. As such at least the LEDs 230, the processor 240, the transmit/receive module 220, the patch antennas 222, the temperature sensor 260, the optical interface unit 280, the optical fibre cable 285, and the power interface 250 are substantially similar or equivalent to the LEDs 30, module 20, antenna 22, temperature sensor 60, optical unit 80 etc. of the first embodiment.

The schematic arrangement of the components in device 200 is as shown in FIG. 3 in respect of the first embodiment. However, the physical arrangement of the components of the device 200 is such that the device 200 has a general rectangular form.

The rectangular form of the device 200 is derived from the base 216, the walls 212 and a lens 219. The base 216 is a rectangular plate which is bordered by four substantially perpendicular panels which form the walls 212.

A side compartment is formed adjacent to the walls 212 by a partition wall 211 which extends away from the base 216 along the width of the base 216 and then extends to meet the proximate side wall or walls 212. Arranged within the compartment are the non-illuminating components 204, specifically the optical interface 280, the temperature sensor 260, the power interface 250 and a piezoelectric sounder 202 (which may be alternatively referred to as a buzzer).

The optical interface 280 is for connection to the local network and as such is provided with an optical fibre communications output cable 285 (typically 1 Gbit/s-10 GBit/s Ethernet).

The power interface 250 receives a 12V DC power supply from outside of the device 200 such that it may suitably convert and distribute electrical power to the other powered components of the device 200.

The partition wall 211 also contributes to the definition of a main compartment, which uses up the majority of the base 216 area. Mounted on the base 216 and within the main compartment is an array of LEDs 230 and an RF transmit/receive module 260. The lens 219 provides a cover for the main compartment.

The array of LEDs 230 are suitably electrically connected together and powered via an electrical connection with the power supply 250. The RF transmit/receive module 260 is connected to the optical interface 280.

The lens 219 comprises an antenna lensing portion L which has an upper surface and a lower surface. The upper surface is equivalently shaped to the upper surface of the lens 18 of the first embodiment and is arranged to manipulate RF radiation (e.g. 55-65 GHz) received and transmitted by an RF antenna module 220. Within the RF antenna module 220, there is provided a transmit patch antenna 222a and a receive antenna 222b.

The upper surface of antenna lensing portion L has a rotated gull-wing shape which provides a toroidal protrusion surface R and hence a central dimple W. The dimple W has a width approximately equal to the separation of the transmit antenna patch 222a and receive antenna patch 222b. Further, the dimple W is arranged to correspond with the boresight of the patch antennas 222a and 222b.

The lower surface of the lensing portion L is generally flat. Further, the lower surface of the lensing portion L directly opposite the valley on the upper surface faces but is separated from the patch antennas 222a and 222b.

Beyond the antenna lensing portion, the lens 219 is substantially straight along the length of the device 200 and may have a slight curve over its width.

The device 200 functions in a similar manner to the first embodiment of the device 100, and operates according to the schematic of FIG. 3.

However, the different shapes of the LED array and the lens provide differing radiation patterns.

In particular, the general circular form of the device 100 tends to emit a narrow beam of light, and so it particularly suited for use as a spotlight.

However, the general rectangular form of the device 200 tends to emit a more diffuse optical radiation pattern and so is more suited to illuminating a space (e.g. a room) entirely.

Referring to FIG. 6, one or more devices may be installed per room and in a location which is suitable for lighting a space and illuminating it with the 55-65 GHz signal to establish respective interfaces 25 and 26. The client devices shown are a tablet-style computing unit 500 and a desktop computing-unit 501, each of these are fitted with a 55-65 GHz transceiver module and associated software or firmware. However, various other devices, if provided with suitable 55-65 GHz transceiver modules and processing capabilities, could be used.

In operation the device 100 or 200 may have various functions which may be run concurrently and generally independently of each other.

In the following examples, the operation of the device will generally be described with reference to the device 100 and the respectively numbered components of device 100; however the operation of the devices 100 and 200 is substantially similar (save e.g. for the beam shaping) and so for the components of the device 100, it should be possible to read in the components of the device 200 instead.

For example, if the smoke sensor 70 is determined by the processor 40 to have detected an unacceptable level of smoke, the processor 40 may cause the piezoelectric actuators 15 to oscillate the lens 18 and thereby aurally alert the local user or users.

As a further example, if the temperature sensor 60 detects a temperature above or below predetermined limits, a signal will be communicated to a temperature control system (not shown) remotely connected to the network 400 via the wireless interface, to effect an increase or decrease in temperature.

Concurrent with either of these exemplary environmental control functions, the local user may have been communicating with the network 400 via the wireless interface 25. For example, the local user S may have been communicating with another user Z using a voice over internet protocol (VoIP) technology.

Alternatively the device 100 may be configured such that the integrated components interact to enhance the facility of each function. For example, as an alternative to the scenario outlined in the immediately preceding paragraph, the device 100 may, instead of only aurally alerting the users, additionally issue a message to the client device 500 (e.g. via the VoIP graphic user interface) and further communicate the alert via the network 400 to a remote super-user.

The exact modes of operation contemplated by the present invention are therefore diverse but would be apparent to the skilled reader upon disclosure of the device.

In operation the device may: act as a wireless connection point for the network 400; provide light to the surroundings, the intensity of which may be controlled; and monitor and warn of environmental conditions.

Furthermore, the devices 100, 200, 300 may be used during the initial building and fitting of any structure (e.g. large habitable constructions such as an office block, or a cruise ship) to assist persons involved with the construction in monitoring, recording, and reporting on construction related matters. For example workmen may report on the level of completion of tasks associated with the project. In particular, the networked 55-65 GHz transceiver 20 could enable paperwork associated with the building process to be viewed, updated or completed on site and in real time, thereby potentially saving many man hours on a project.

Given the shape of the lens 18 and the respective positioning of the light sources 30 and the transceiver 20 thereto, the devices 100, 200, 300 provide for broad spectrum coverage in the far field electromagnetic radiation pattern at not only the visible frequencies but also the 55-65 GHz frequency.

In further embodiments, the device 100 or 200 may be provided with an infra-red sensor, being electrically connected to the power unit 50 and processor 40 such that a local user may control e.g. the intensity of the light.

The lenses 18 and 219 may be made from any material which is suitably transmissive of the majority of the wavelengths in visible light and is also suitably transmissive of the 55-65 GHz radio signal. Particular materials identified for the lenses 18, 219 are therefore High Density Polyethylene (HDPE), Polycarbonate and Quartz. Polymeric lens materials may be particularly convenient to shape and also offer generally good toughness and durability.

The piezoelectric pillars 15 may be formed from stacks of Polyzirconium Titanate (PZT).

At least the temperature sensors 60, 260 (e.g. a thermocouple), the processors 40, 240 (e.g. a Xilinx FP), the power units 50, 250, the smoke sensor 70, the LEDs 30, 230, and the optical interface units 80, 280 may be off-the shelf instances of such components and as such should be well known to the skilled man. Further discussion of the fabrication of these components will therefore be avoided for sake of conciseness.

The optical fibre cable 85, 285 may be provided with at least a pair of optical fibres, such that at least one optical fibre may be used for communicating data received at the device, and at least one optical fibre may be used for communicating data to the device for transmission. Thus concurrent forward and backward signals are provided for. Alternatively, the optical fibre cable 85, 285 may be provided with a single optical fibre and, in order to permit concurrent forward (transmit) and backward (receive) signals, wavelength division multiplex means provided as appropriate at the device 100,200.

Further, the skilled man would be aware of local regulations, relating to e.g. fire/smoke safety systems, and be able to adapt or exclude components within/from the system as appropriate.

Still further, the skilled man would appreciate that whilst a single device 100 or 200 may have a limited coverage, a plurality of devices 100 or 200 would be able to cover larger areas and spaces.

1. An integrated lighting and network-interface device comprising a housing defining an aperture, a lens supported at the aperture for allowing light and 55-65 GHz radiation to pass therethrough, a light source, a transceiver module having an antenna unit, the transceiver module being adapted for connection to an optic fibre port, and being for operation at at least one centre frequency between 55 GHz and 65 GHz, wherein the light source and the antenna unit are disposed in the housing and arranged to radiate through the lens.

2. A device according to claim 1 comprising a modem, the modem being for interfacing the transceiver module with the fibre optic port.

3. A device according to claim 1 wherein the light source is rated at between 30 and 60 W.

4. A device according to claim 1, wherein the device comprises a processor configured to communicate with the light source and with the 55-65 GHz transceiver module.

5. A device according to claim 1 wherein the lens comprises an outer surface facing away from the antenna unit, and an inner surface facing the antenna unit, and wherein the lens further comprises a raised-profile portion, the raised-profile portion defining a profile axis and having about the profile axis a generally gull-wing cross-section so as to define on the outer surface of the raised-profile lens a valley interposed between a pair of peaks, the valley coinciding with the profile axis and wherein the antenna unit is arranged such that the boresight of the antenna unit is proximate to the profile axis of the lens.

6. A device according to claim 5 wherein the inner surface of the lens comprises a convex surface portion at the profile axis which is surrounded by a toroidal concavity, and wherein the light sources are proximate to the toroidal concavity.

7. A device according to claim 1 wherein the device comprises a plurality of light sources arranged around the transceiver module and generally occupying the space defined under the lens.

8. A device according to claim 1 wherein the lens is formed from High Density Polyethylene or Polycarbonate

9. A device according to claim 1 wherein the device further comprises environmental sensors, which are configured to communicate with the a processor.

10. A device according to claim 1 wherein the housing comprises a base and walls extending from the base to the lens, such that the lens, base and walls provide an enclosure.

11. A device according to claim 10 wherein the base is circular, the lens is circular so as to correspond to the base, and the light source comprises a plurality of light sources arranged around the transceiver module in a ring.

12. A device according to claim 10 wherein the base is rectangular, the lens is rectangular so as to correspond to the base, and the light source comprises an array of regularly spaced light sources arranged in a grid corresponding to the base.

13. A device according to claim 10 wherein the walls comprise at least one piezoelectric actuator which is arranged to support the lens and wherein the device is provided with a signal generator for driving the piezoelectric actuators.

14. A device according to claim 1 wherein the light source comprises a plurality of LED units.

15. An integrated lighting and network-interface device comprising:
a housing defining an aperture;
a light source rated at between 30 and 60 W;
a lens supported at the aperture for allowing light from the light source and 55-65 GHz radiation to pass therethrough;
a transceiver module having an antenna unit, the transceiver module being adapted for connection to an optic fibre port, and being for operation at at least one centre frequency between 55 GHz and 65 GHz; and
a processor configured to communicate with the light source and with the transceiver module;
wherein the light source and the antenna unit are disposed in the housing and arranged to radiate through the lens.

16. A device according to claim 15 comprising a modem, the modem being for interfacing the transceiver module with the fibre optic port.

17. A device according to claim 15 wherein the lens comprises an outer surface facing away from the antenna unit, and an inner surface facing the antenna unit, and wherein the lens further comprises a raised-profile portion, the raised-profile portion defining a profile axis and having about the profile axis a generally gull-wing cross-section so as to define on the outer surface of the raised-profile lens a valley interposed between a pair of peaks, the valley coinciding with the profile axis and wherein the antenna unit is arranged such that the boresight of the antenna unit is proximate to the profile axis of the lens, and wherein the inner surface of the lens comprises a convex surface portion at the profile axis which is surrounded by a toroidal concavity, and wherein the light sources are proximate to the toroidal concavity.

18. A device according to claim 15 wherein the device further comprises environmental sensors, which are configured to communicate with a processor.

19. An integrated lighting and network-interface device comprising:
a housing defining an aperture;
a light source comprising a plurality of LED units;
a lens supported at the aperture for allowing light from the light source and 55-65 GHz radiation to pass therethrough;
a transceiver module having an antenna unit, the transceiver module being adapted for connection to an optic fibre port, and being for operation at at least one centre frequency between 55 GHz and 65 GHz; and
a processor configured to communicate with the light source and with the transceiver module;
wherein the light source and the antenna unit are disposed in the housing and arranged to radiate through the lens.

20. A device according to claim 19 wherein the LEDs are arranged around the transceiver module and generally occupy space defined under the lens.
